(19) United States
(12) Patent Application Publication
(10) Pub. No.: US 2006/0095617 A1
(43) Pub. Date: May 4, 2006

(54) Processing architecture for directly playing audio/video signal

(76) Inventor: Tsung-Yung Hung, Taipei (TW)

Correspondence Address: LIN & ASSOCIATES INTELLECTUAL PROPERTY, P.O. BOX 2339, SARATOGA, CA, 95070-0339, US

(21) Appl. No.: 10/978,052

(22) Filed: Oct. 30, 2004

(51) Int. Cl. G06F 13/38

(52) U.S. Cl. 710/69

(57) ABSTRACT

Disclosed is a processing architecture that converts a notebook computer into an audio/video playing device for directly playing an audio/video signal without activating a central processing unit of the notebook computer, wherein, without activating the central processing unit, the processing architecture receives an audio/video signal through an analog audio/video interface, which applies an analog signal to an analog-to-digital converter to provide a digital signal. The digital signal is then processed in sequence by an audio/video processor and a low voltage differential signaling (LVDS) processor to provide an LVDS signal that is selectively applied to a display screen and a speaker of the notebook computer to be played and/or broadcast by the display screen and the speaker.

### BACKGROUND OF THE INVENTION

1. Field of the Invention

The present invention relates generally to a processing architecture for directly playing audio/video signals, and in particular to a processing architecture that converts a notebook computer into an audio/video playing device.

2. The Prior Arts

Notebook computers are gradually becoming one of the most prevailing computer products for general consumers. For those traveling frequently, the notebook computer is the most convenient computer product due to portability. In addition, currently, the operation system of the notebook computer has been developed to allow for playing of television programs with the aid of a TV card and digital playing software. This allows the notebook computer to function like an audio/video signal playing device, just like a TV set.

When the notebook computer is playing a TV program or other audio/video signal received through the TV card, the computer does nothing but playing the audio/video contents carried by the received TV or other audio/video signals. A central processing unit of the notebook computer, which is responsible for data processing in performing different operations of the computer, such as surfing internet by browser software in which the central processing unit is maintained in a multi-tasking condition, does not get involved in the playing of the audio/video signals, yet the central processing unit is still in an activated condition, which consumes a great amount of power. Thus, compared to a TV set, playing audio/video signals with a notebook computer consumes much more power. This is quite disadvantageous for the notebook computer for the notebook computer is a portable device that is often powered by built-in, rechargeable power supply, such as a secondary battery set.

It is thus desired to have a processing architecture that allows the notebook computer to directly play audio/video signals without activating the central processing unit for reduction of power consumption.

### SUMMARY OF THE INVENTION

An objective of the present invention is to provide a processing architecture that converts a notebook computer into an audio/video playing device that directly plays the audio/video signal with the display screen and speaker of the computer without activating a central processing unit of the computer so as to reduce power consumption in playing audio/video signals.

Another objective of the present invention is to provide a processing architecture that allows for efficiently and conveniently play audio/video signals with a display screen and a speaker of a notebook computer without activating a central processing unit of the computer first.

A further object of the present invention is to provide a processing architecture that works with a notebook computer to play audio/video signals and that is controllable by a remote control to allow a user to conveniently control the operation of playing the audio/video signals through the notebook computer.

A further object of the present invention is to provide a processing architecture that is incorporated in a notebook computer to play audio/video signals with a display screen and a speaker of the computer and that comprises a control panel formed on a casing of the notebook computer and having a plurality of control keys to allow a user to conveniently control the operation of playing the audio/video signals through the notebook computer.

Yet a further object of the present invention is to provide a processing architecture that is incorporated in a notebook computer to play audio/video signals with a display screen and a speaker of the computer and that comprises a secondary display panel formed on a casing of the notebook computer to indicate the operation status of playing the audio/video signals through the notebook computer.

In accordance with the present invention, to realize the above objectives, a processing architecture for directly playing audio/video signal is incorporated in a notebook computer that comprises at least a power supply, a display screen, such as a liquid crystal display (LCD), and a speaker. The processing architecture functions to control an audio/video processing circuit to activate the display screen, the speaker, and an audio/video processor with power supplied from the power supply of the notebook computer under the condition that a central processing unit of the notebook computer is not activated. The audio/video signal, which is originally an analog signal received through an analog audio/video interface, is converted by an analog-to-digital converter into a digital signal. The digital signal is then fed to and processed by the audio/video processor, which supplies a processed digital. The processed digital signal is then fed to and processed by a low voltage differential signaling (LVDS) processor, through which the processed digital signal is converted into an LVDS signal that is then fed to the display screen and the speaker for displaying and/or broadcasting of the audio/video signal.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is a perspective view showing a notebook computer in which an audio/video signal processing architecture constructed in accordance with a first embodiment of the present invention is incorporated;

FIG. 2 is a block diagram of the audio/video signal processing architecture of the present invention;

FIG. 3 is a perspective view showing a notebook computer in which an audio/video signal processing architecture constructed in accordance with a second embodiment of the present invention is incorporated; and

FIG. 4 is a perspective view showing a notebook computer in which an audio/video signal processing architecture constructed in accordance with a third embodiment of the present invention is incorporated.

### DETAILED DESCRIPTION OF THE PREFERRED EMBODIMENTS

An audio/video signal processing architecture in accordance with the present inventions is provided to directly playing an audio/video signal through a notebook computer without activating a central processing unit of the notebook computer whereby power consumed by the notebook computer in playing the audio/video signal can be substantially reduced. This architecture is done by providing the notebook computer with additional electrical circuits/components that work with the original circuits/components of the notebook computer to serve as an audio/video playing device. Thus, the processing architecture does not just comprise a single component, and instead, it comprises all components and circuits, including the additional and the computer-original components/circuits that realize the function of directly playing the audio/video signal through the notebook computer.

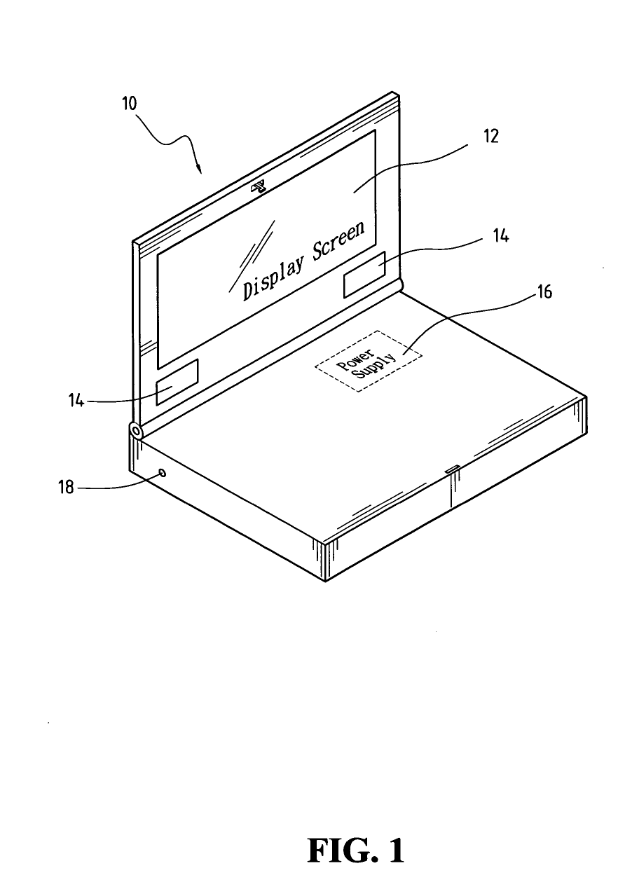

With reference to the drawings, and in particular to FIG. 1, a notebook computer is shown, generally designated with reference numeral 10, comprising a power supply 16, a display screen 12, and a speaker 14, which constitute the computer-original components/circuits that is comprised, partly, of the processing architecture in accordance with the present invention.

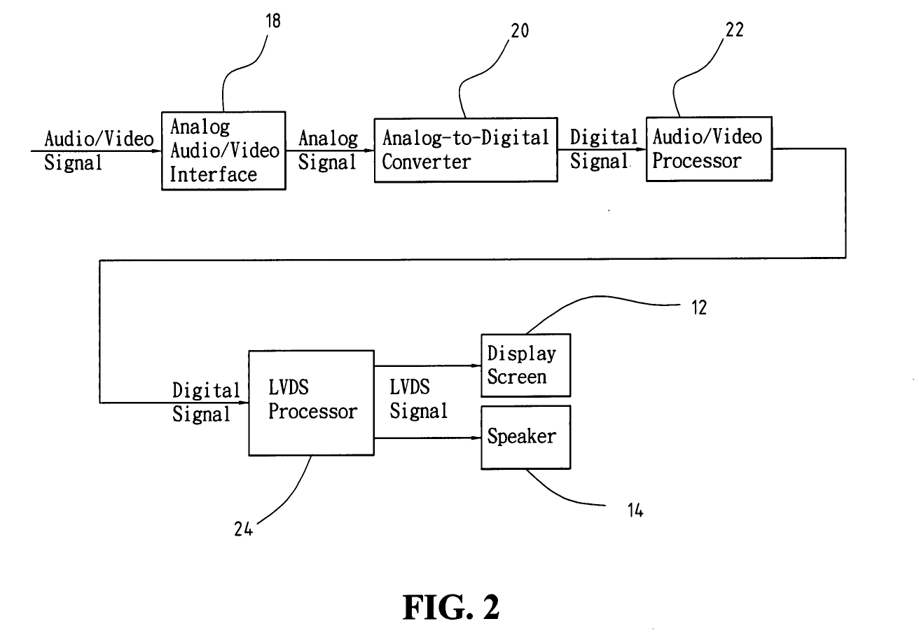

Also referring to FIG. 2, besides the computer-original components/circuits, the processing architecture in accordance with the present invention further comprises additional components/circuits, which constitute a block diagram illustrated in FIG. 2. The additional components/circuits of the processing architecture include an analog audio/video interface 18 that receives an audio/video signal from an external source (not shown) and applies a corresponding analog signal to an analog-to-digital converter 20. The analog-to-digital converter 20 converts the analog signal into a digital signal that is fed to and processed by an audio/video processor 22 to generate a processed digital signal. The processed digital signal is then fed to a low voltage differential signaling (LVDS) processor 24, which in turn selectively provides an LVDS signal to both the display screen 12 and the speaker 14 of the notebook computer 10 through which video and audio components of the audio/video signal from the external source are displayed and/or broadcast.

Examples of the analog audio/video interface 18 include a TV tuner and an AV/S terminal.

All the components/circuits, including both the computer-original components/circuits and the additional components/circuits, are together referred to as “audio/video processing circuit”, which uses the power from the power supply 16 of the notebook computer 10 illustrated in FIG. 1 to power the display screen 12, the speaker 14, the audio/video processor 22, the analog audio/video interface 18, the analog-to-digital converter 20, and the LVDS processor 24, which are electrically connected to each other and communicate with each other for signal transfer and exchange.

The power supply 16 of the notebook computer 10 in accordance with the present invention may comprise a built-in power supply of a regular notebook computer, or alternatively it can be charged by an external power supply (not shown).

When the processing architecture is activated, the power supply 16 supplies power to the audio/video processing circuit to activate the display screen 12, the speaker 14, and the audio/video processor 22, while the central processing unit, chipsets, memory of the notebook computer 10 that are generally required by executing the operation system of the computer are maintained un-activated. In other words, the processing architecture of the present invention can be activated independently of the basic architecture of the notebook computer 10.

Once the audio/video processor 22 is activated and ready to operate, the analog audio/video signal received by the analog audio/video interface 18 is processed sequentially by the analog-to-digital converter 20, the audio/video processor 22, the LVDS process 24, and then display/broadcast through the display screen 12 and the speaker 14.

Thus, in accordance with the present invention, the processing architecture supplies, without activating the central processing unit, the audio/video signal to proper components/circuits through the audio/video processing circuit, but not through the central processing unit and the chipset and without the control of the computer operation system. This allows the audio/video signal to be played through the display screen and speaker of the computer without activating the central processing unit. That means the processing architecture of the present invention converts the notebook computer, which is a high power consumption device in regular operation, into an audio/video playing device that consumes much less power than a regular notebook computer. Also, since the playing of the audio/video signals through the display screen and/or speaker of the notebook computer does not require the activation of the central processing unit and chipset of the notebook computer, the initialization process of the processing architecture can be very efficient, as compared to that of a regular notebook computer. Thus, the audio/video signal can be played in an efficient and convenient manner.

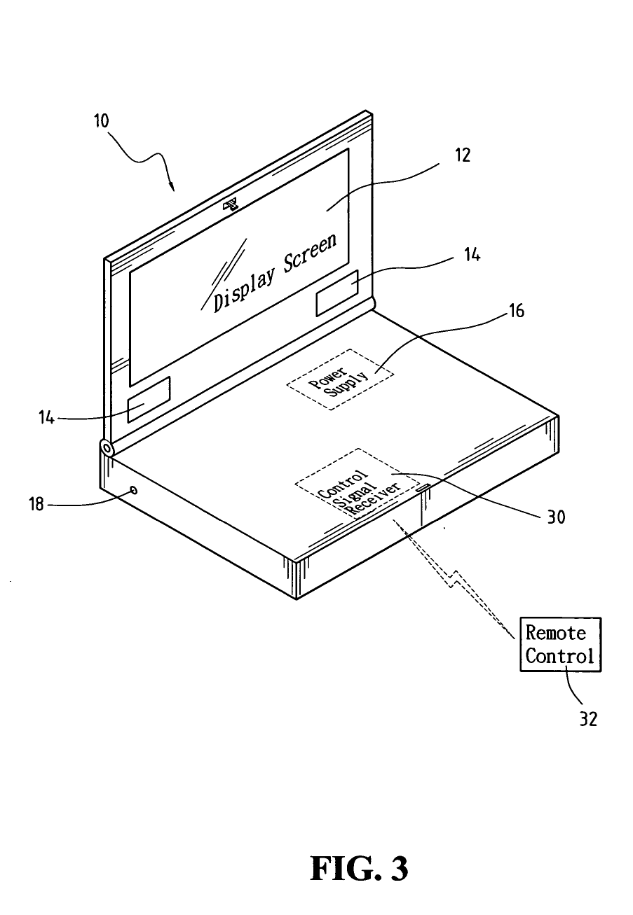

Also referring to FIG. 3, a second embodiment of the present invention is shown, wherein for simplicity, like parts are designated with the same reference. The processing architecture in accordance with the second embodiment comprises a remote control 32 and a control signal receiver 30 that is installed in the notebook computer 10. The remote control 32 is provided with a plurality of control buttons (not shown), each of which when actuated, generates a particular control signal that is transmitted to the control signal receiver 30 for controlling the operation of the processing architecture and that of the computer, if desired. These control buttons comprise at least a power key, a play/pause key, a next section play key, a previous section play key, a stop key, a fast-forward key, and a fast-backward key.

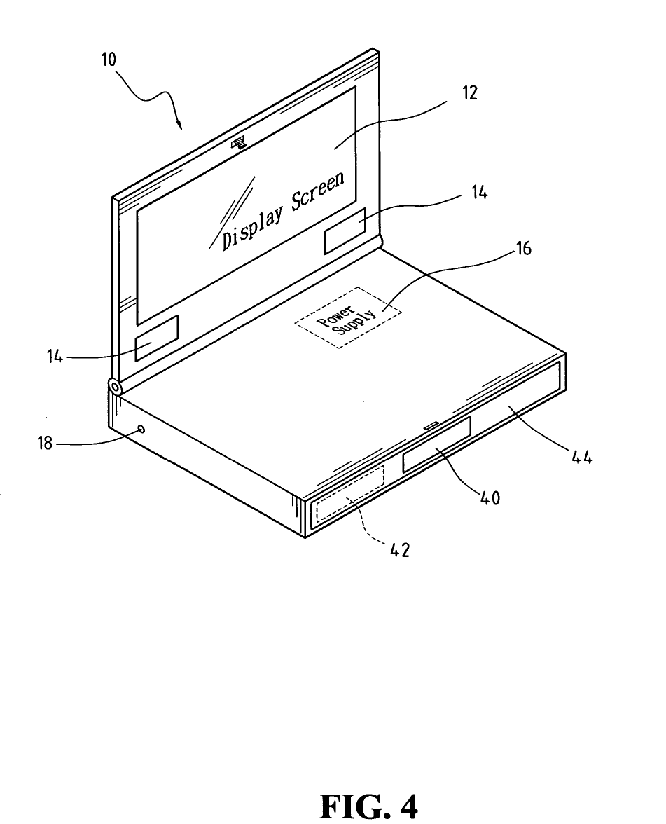

Referring to FIG. 4, a third embodiment of the present invention is shown, wherein for simplicity, like parts are designated with the same reference. The processing architecture in accordance with the third embodiment comprises a control panel 44 that is for example mounted to a casing of the notebook computer 10, for controlling the operation of the processing architecture in playing audio/video signal received from the external source. The control panel 44 comprises a keypad 42 in which a plurality of control keys (not shown), such as a power key, a play/pause key, a next section play key, a previous section play key, a stop key, a fast-forward key, a fast-backward key, similar to those provided on the remote control 32 discussed with reference to FIG. 3, are provided, and a secondary display 40 that shows the operation status of the playing of the audio/video signal by the processing architecture of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A processing architecture adapted to work with a notebook computer that comprises a central processing unit, a display screen, and a speaker all powered by a power supply of the notebook computer, for directly playing an audio/video signal with the display screen and the speaker without activating the central processing unit of the computer, the processing architecture comprising an audio/video processing circuit that activates the display screen, the speaker, the audio/video processing circuit comprising:
an analog audio/video interface adapted to receive the audio/video signal from an external source;
an analog-to-digital converter that receives an analog signal from the analog audio/video interface and converts the analog signal into a first digital signal;
an audio/video processor that receives and processes the first digital signal and generates a second digital signal; and
a low voltage differential signaling processor that receives the second digital signal and generates and selectively applies an output signal to the display screen and the speaker.

2. The processing architecture as claimed in claim 1, wherein the audio/video processing circuit is powered by the power supply to electrically connect the display screen, the speaker, the audio/video processor, the analog audio/video interface, the analog-to-digital converter, and the low voltage differential signaling processor that communicate with each other for data transfer and exchange.

3. The processing architecture as claimed in claim 1, wherein the analog audio/video interface comprises a TV tuner.

4. The processing architecture as claimed in claim 1, wherein the analog audio/video interface comprises an AV/S terminal.

5. The processing architecture as claimed in claim 1 further comprising a control panel mounted to a casing of the notebook computer.

6. The processing architecture as claimed in claim 1 further comprising a remote control and a control signal receiver adapted to arranged in the notebook computer for receiving a control signal from the remote control to control the operation of the processing architecture.

7. The processing architecture as claimed in claim 5, wherein the control panel comprises a power key, a play/pause key, a next section play key, a previous section play key, a stop key, a fast-forward key, and a fast-backward key.

8. The processing architecture as claimed in claim 6, wherein the remote control comprises a power key, a play/pause key, a next section play key, a previous section play key, a stop key, a fast-forward key, and a fast-backward key.

9. The processing architecture as claimed in claim 5, wherein the control panel comprises a secondary display.
